(19) United States
(12) Patent Application Publication
(10) Pub. No.: US 2015/0197305 A1
(43) Pub. Date: Jul. 16, 2015

(54) Colapsible Scooter

(71) Applicant: Hans Christian Boes, Berlin (DE)

(72) Inventor: Hans Christian Boes, Berlin (DE)

(21) Appl. No.: 14/589,295

(22) Filed: Jan. 5, 2015

(30) Foreign Application Priority Data
Jan. 7, 2014 (DE) 20 2014 0001425.1

(51) Int. Cl. B62K 15/00; B62K 21/16; B62K 3/00; B62B 3/00

(52) U.S. Cl. CPC B62K 15/006; B62B 3/008; B62K 21/16; B62K 3/002; B62K 2015/005

(57) ABSTRACT

A collapsible scooter is presented with a large front wheel, which still can be rolled in the folded state—similar to a shopping trolley—and which also can carry goods when folded. This is achieved by attaching two small wheels at the front of the footboard that do not touch the ground when the scooter is in the unfolded state but that come down on the ground when the scooter is in the folded position.

By means of a rack or a luggage carrier on the front wheel about any shape of removable tote bags, suitcases, boxes and baskets can be attached right and left or on top of the front wheel.

### TECHNICAL PROBLEM

Foldable scooters have been around for more than 20 years, they have been very popular during the late 1990s especially with children. The great advantage of a foldable scooter in contrast to the non folding scooter is that the scooter can be taken in other vehicles (such as a car, train or bus).

However, the current standard foldable scooters usually have the disadvantage that their front wheels are very small and thus have a tendency to stop at an obstacle, so that the driver can easily fall forward. For this reason, scooters with a larger front wheel find an increasing tendency on the market. However, these folding scooters cannot be rolled in the collapsed state so that they have to be carried. They often must be packed in a carrying case so you can take them for example on the train or bus. Moreover no goods can be transported with these scooters when they are folded.

### Solution to the Problem and Advantageous Effects of Invention

Therefore I have constructed a collapsible scooter with a large front wheel, which still can be rolled in the folded state—similar to a rolling suitcase or a shopping trolley—and which also can carry goods when folded because the front fork of the scooter stays in the upright position when folded.

By means of a rack or a luggage carrier on the front wheel about any shape of removable tote bags, suitcases, boxes and baskets can be attached right and left or on top of the front wheel. Two examples of this scooter can be seen on my website:

http://www.postfossilemobile.de/der-neue-klapproller/

Therfore it is possible with this utility patent to create a suitcase in which the scooter is fully integrated. This will be a rolling suitcase with a folding footboard. In contrast to today's popular rolling luggage only a big wheel and a corresponding steering linkage will be integrated in the middle of the suitcase.

### BRIEF DESCRIPTION OF DRAWINGS

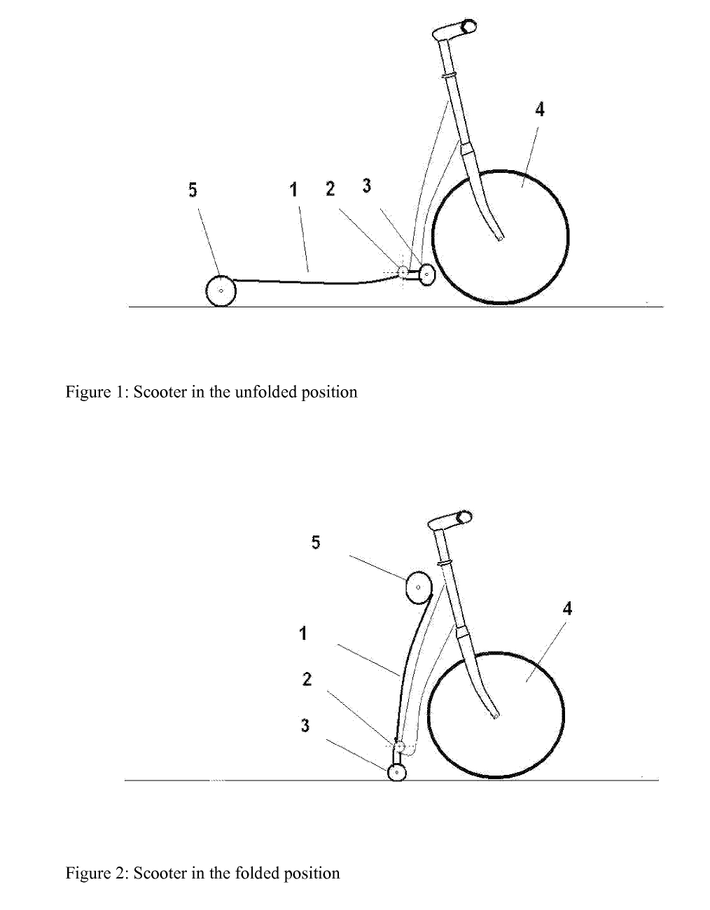

The scooter (FIG. 1) consists of a large front wheel (4) and a smaller rear wheel (5). The footboard (1) can be folded around a joint (2). At the front end of the footboard two small wheels (3) are mounted left and right, which in the unfolded state of the footboard do not touch the ground (FIG. 1). In the folded state (FIG. 2) these wheels (3) touch the ground and provide a stable stance of the scooter on the large front wheel (4) and the two small wheels (3) and the vehicle can still be rolled upright. The upright position of the front fork does not change through the folding and thus also the position of any attached bags or containers to the front fork.

The joint (2) can be locked both in the unfolded and in the folded state.

At the front fork and a rack or a basket can be mounted so as shopping or other things can be taken along with the folding scooter. This turns the folding scooter in the folded state in effect into a rolling trolley that can be pushed very good (like a bicycle) by holding the roller on the handlebar and steer the front wheel as it rolls on the two small folding wheels (3).

The small folding wheels (3) are connected to the footboard support structure so as to allow easy passage of the scooter down stairs in the collapsed state similar to a sack barrow. Thus the collapsed scooter can be easily moved backwards even over steps.

### DESCRIPTION OF EMBODIMENTS

Two examples of the collapsible scooter can be seen on my website

http://www.postfossilemobile.de/der-neue-klapproller/

It shows the scooter in the unfolded and the folded state with a basket on top and in another example with a rack that can be used to attach removable tote bags. Also you can see the small wheels at the front of the footboard that do not touch the ground when the scooter is in the unfolded state, ready for scooting. When in the folded state, the small wheels do touch the ground and the scooter can be used as a trolley.

The small wheels are attached to the footboard in a manner similar to a sack barrow wich allows the scooter in the folded state to be pulled over steps.

1. A collapsible scooter
where at the front of the footboard (1) two wheels (3) are mounted right and left, which do not touch the ground in the unfolded state, however touching the ground in the folded state of the scooter and thereby making the scooter in the folded state upright rollable.

2. Scooter according to claim 1,
where the hinge (2) in the folded and the unfolded state is safely locked.

3. scooter according to the preceding claims,
where the hinge (2) can be locked securely via a cable or a lever device from the handlebar and released again.

4. scooter according to the preceding claims,
where the front wheels of the footboard (3) are not firmly attached to the footboard (as described in the embodiment), but are brought via a lever mechanism to contact the ground when folding.

5. scooter according to the preceding claims,
where only one or more than two wheels (3) are attached to the front part of the footboard.

6. scooter according to the preceding claims,
a) where a removable case or a removable bag or other removable transport vessel is attached to the front fork.
b) where the scooter is fully integrated into a suitcase or other transport vessel.

7. scooter according to the preceding claims,
where the folding wheels (3) are connected with the footboard and the footboard substructure such as that they allow easy passage of the scooter down or up stairs when folded, like a common sack barrow.

8. scooter according to the preceding claims,
where an electric drive (electric motor) is integrated into the scooter.

9. scooter according to the preceding claims,
where the handlebar is designed folding or retractable.

10. scooter according to the preceding claims
where instead of folding wheels (3) skids are used.
